(19) United States
(12) Patent Application Publication
(10) Pub. No.: US 2003/0081975 A1
(43) Pub. Date: May 1, 2003

(54) Method and apparatus for printing using staggered pens

(76) Inventor: Stephen W. Bauer, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/999,853

(22) Filed: Oct. 31, 2001

(51) Int. Cl. B41J 2/155; B41J 2/145

(52) U.S. Cl. 400/149; 347/37; 347/40

(57) ABSTRACT

Banding at swath boundaries in inkjet printer output is reduced by staggering the pens in the printer so that that the swath produced by each pen overlaps with, but is not coincident with, the swath produced by any other pen in the printer. This may be achieved by physically staggering the pens in the printer, or by selecting a subset of ink nozzles to create a virtual pen that is offset from the subset of ink nozzles selected for each other virtual pen.

### FIELD OF THE INVENTION

The invention relates to a method of reducing banding errors in printer output. Specifically, the invention relates to printers and printing methods that reduce banding errors by staggering the positions of the pens.

### BACKGROUND OF THE INVENTION

A variety of printers, including inkjet printers, apply ink from one or more pens in multiple passes across a print medium. The area on the printed page that is covered in a single pass of a pen is generally referred to as a swath, and the print medium is generally advanced, or ‘stepped’ between passes by an amount approximately equal to the height of the pen swath. As a result, the printed output of such a printer can be considered to consist of a series of image ‘bands’, each band corresponding to a pass of the pen.

The quality of the output of an individual printer may be compromised by a variety of printing errors. Discontinuities in color or apparent luminance at swath boundaries may arise from differences in ink application between print passes, meshing the output of nozzles from different areas of the pen, or the differential mobility of wet ink applied adjacent dry ink from the previous pass. Such discontinuities are typically referred to as ‘banding’, and at worst case, banding includes the presence of visually obvious non-printed gap between print swaths. Banding may be emphasized by a variety of printer conditions, but it is most typically related to step advance errors when advancing the print medium.

What is needed is a method of minimizing or de-emphasizing banding in printer output. This method could be utilized in existing printers without requiring expensive physical modification of the printer, perhaps by applying a software upgrade.

### SUMMARY OF THE INVENTION

The present invention reduces banding in a printer having at least two pens. The method of the invention includes the steps of moving the pens across the print medium, and dispensing ink from each pen to produce a swath on the print medium corresponding to each pen, where the relative position of each pen is such that the swath produced by each pen overlaps with, but is not coincident with, the swath produced by any other pen.

### BRIEF DESCRIPTION OF THE DRAWINGS

FIG. 1 is an isometric view of an inkjet printer incorporating a pen arrangement in accordance with one embodiment of the present invention.

FIG. 2 is schematic representation of a pen arrangement having four pens, including a depiction of an exemplary swath printed by one or more of the pens on a print medium.

FIG. 3 is a schematic representation of a pen arrangement incorporating pens arranged in accordance with one embodiment of the present invention, including a depiction of representative swaths printed by each pen on a print medium.

FIG. 4 is a schematic representation of the pen carriage of FIG. 3, showing measurements of pen offset and pen height.

FIG. 5 is a schematic representation of an alternate embodiment of a pen arrangement according to the invention.

FIG. 6 is a schematic representation of an electronic image, indicating the start points of the pen data for each of four staggered pens, and their relative offset.

FIG. 7 is a flow diagram showing a method of printing using a printing system according to one embodiment of the present invention.

### DETAILED DESCRIPTION AND BEST MODE OF THE INVENTION

The invention includes a method of reducing output banding in an inkjet printer by moving one or more pens across a print medium and dispensing ink from each pen to produce a swath on the print medium, while ensuring that the relative position of each pen is such that the swath produced by each pen overlaps with, but is not coincident with, the swath produced by any other pen. Typically, each swath has the same width and height, but the swaths are progressively offset along a selected axis so that the swath produced by each pen overlaps yet is distinct from the swath produced by any other swath.

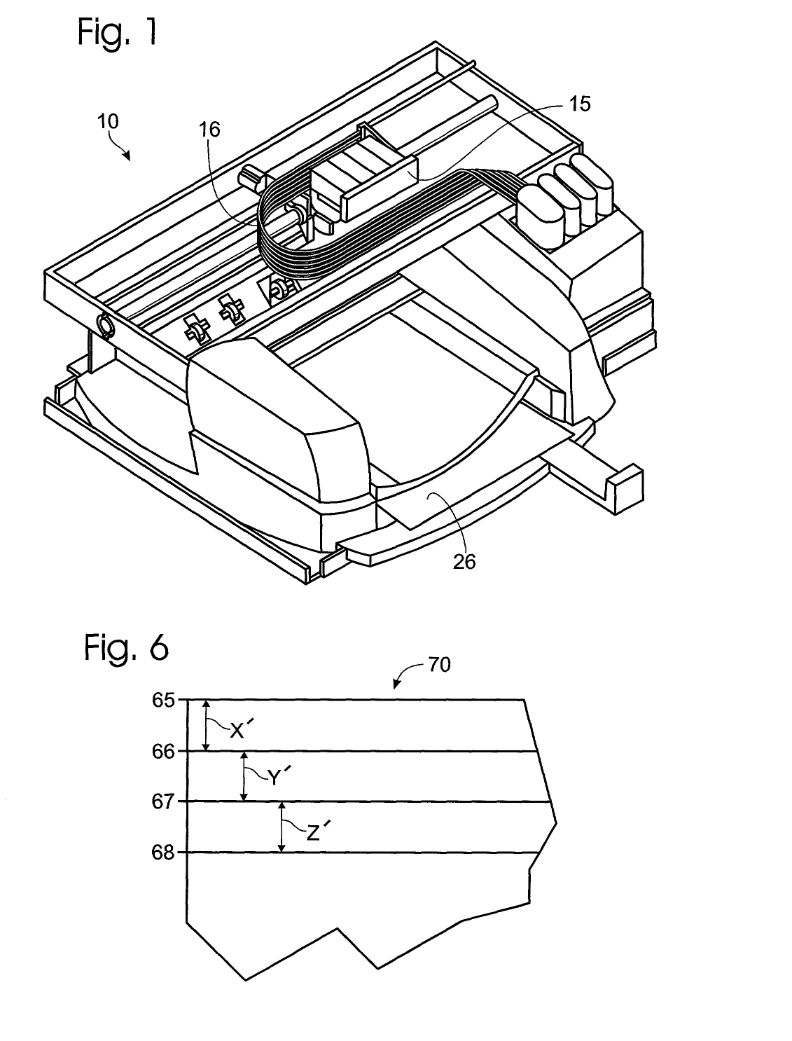

FIG. 1 shows an inkjet printer 10, including a pen carriage 15 that includes a plurality of pens. During printing, the pen carriage is moved side-to-side across a print medium 26 to facilitate deposit of a swath of ink on the print medium via the onboard pens. The pen carriage typically includes a mechanical mounting and flexible cabling connections 16 to a pen carriage drive circuit board.

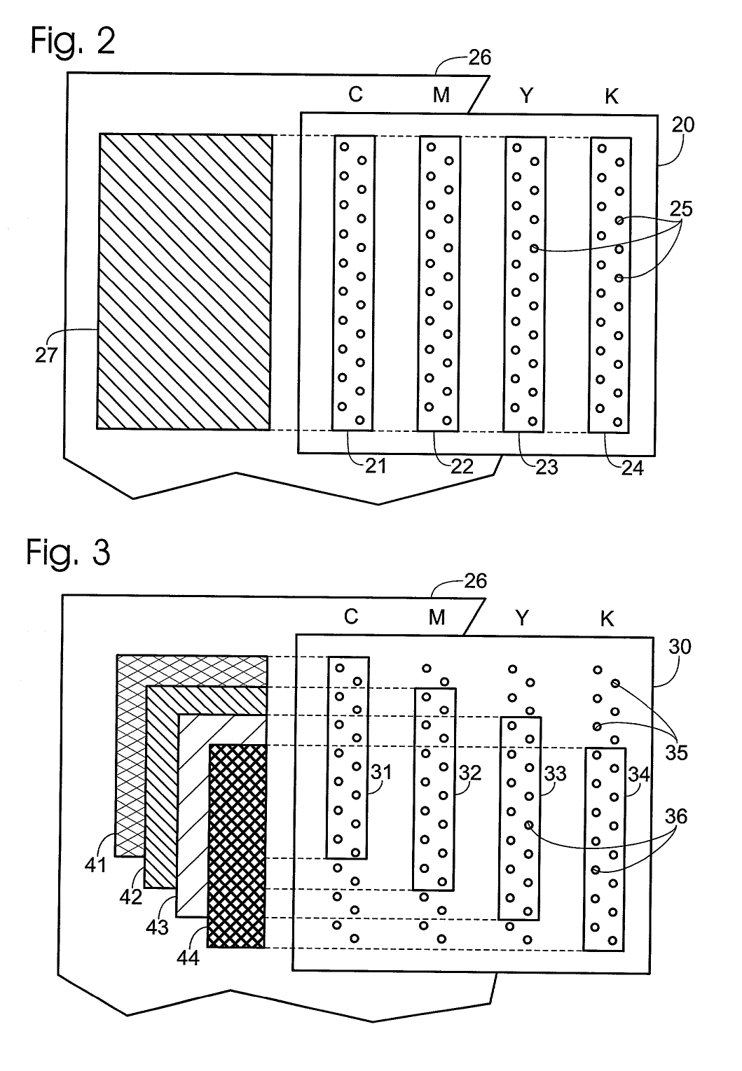

Details of the arrangement of pens 20 of printer 10 are shown in the schematic of FIG. 2. The depicted pen arrangement incorporates a plurality of ink nozzles in four groups labeled C, M, Y, and K. Each group of ink nozzles is configured to dispense a distinct ink. A collection of ink nozzles that are grouped together and selectively dispense the same ink simultaneously are collectively referred to herein as a pen. It will be appreciated that pens may be structurally distinct from one another, or incorporated into one or more unitary pen structures. Pen arrangement 20 of FIG. 2 includes four pens, 21, 22, 23, and 24.

The pens may utilize any of a number of mechanisms to deposit ink, as known in the art, including without limitation electrostatic mechanisms, thermal mechanisms, or piezoelectric mechanisms. As depicted in FIG. 2, the pens are designated as C (cyan), M (magenta), Y (yellow), and K (key, or black) in correspondence with the type of ink they dispense. Printers utilizing CMYK ink systems are well known in the art. However, the method and printer of the present invention may be utilized with any ink color desired, and virtually any number of suitable staggered pens.

FIG. 2 shows a representation of a print swath 27 produced by pens 21-24 on a typical print medium 26. As shown, the swath of each of pens 21-24 overlaps and is completely coincident with the swath of each other pen 21-24. In this case, banding errors can readily arise. At each swath boundary, wet ink is applied adjacent to drier ink applied during a previous pass. In addition, across each swath boundary ink is applied by nozzles from different areas of each pen. These conditions may result in perceptible differences in color or luminance at the swath boundaries. Where the print medium advance between swaths is not coordinated with the swath height (known as a step advance error) visually obvious non-printed gaps between adjacent print swaths may result.

The present invention renders such banding errors less noticeable by staggering the location of each pen relative to the other pens. Typically, each pen is staggered with respect to every other pen in a direction perpendicular to the direction of travel of the pen carriage and parallel to the plane of the print medium. The degree that a given pen is staggered will herein be referred to as the offset for that pen, or the pen offset. By selectively enabling only the desired ink nozzles, four staggered virtual pens are created, as shown in FIG. 3.

Pen arrangement 30 of FIG. 3 includes both active ink nozzles 36 and inactive ink nozzles 35. By selection of a particular subset of ink nozzles, four virtual pens 31, 32, 33, and 34, are defined, each offset relative to each other pen. Again, virtual pens 31-34 are depicted as dispensing cyan, magenta, yellow and black inks, but they may be selected to dispense any desired type or color of ink, in any combination. The printer of the invention may have two pens, four pens, six pens, or any other desired number of pens dispensing any appropriate ink color or colors.

In contrast to the swath printed by the pen arrangement of FIG. 2, where the swath printed by each pen is fully coincident, FIG. 3 depicts pen swaths 41-44 (corresponding to staggered virtual pens 31-34) that overlap but are not coincident with each other. In this way, banding errors that occur at the swath boundaries for a particular pen are not coincident with the banding errors at the swath boundaries for any other pen. Step function-related discontinuities in the printer output thus may be distributed across all of the pens, and are much less noticeable. Whereas a typical printer may produce output containing white (non-printed) regions between adjacent swaths, such swath boundaries would be overwritten by at least one other pen when using the virtual pen arrangement of FIG. 3. Banding is therefore rendered much less noticeable in the output of the printer of the invention.

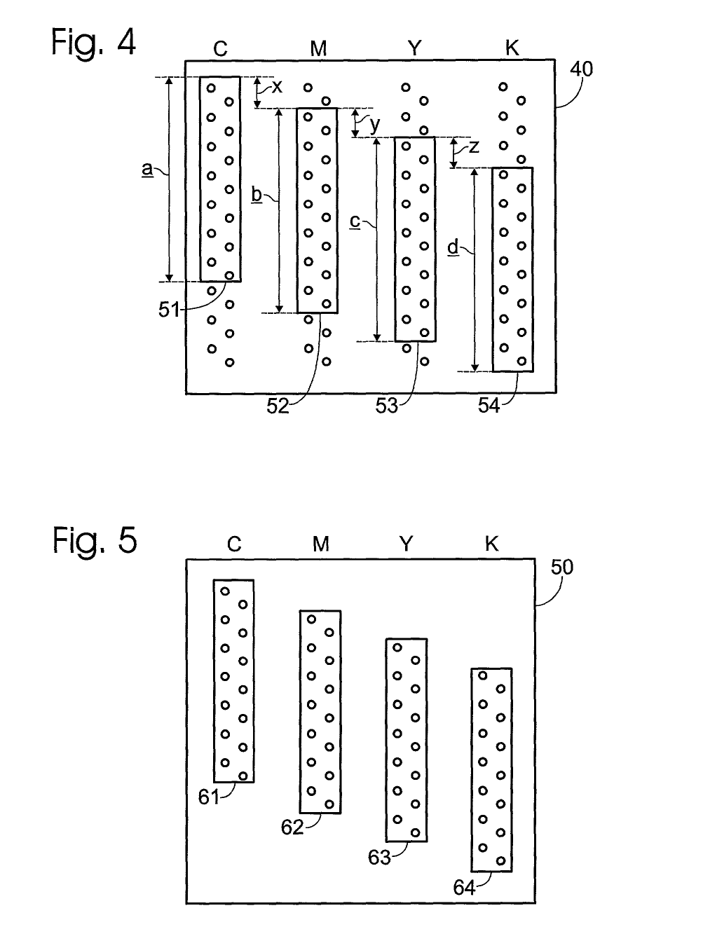

As shown in FIG. 4, a pen arrangement 40 of staggered virtual pens 51-54 are created by selection of a subset of active ink nozzles. In order to be able to advance the print medium a fixed and consistent amount after each pass of the printhead, it is preferred that the height of each virtual pen be equal. In the example shown in FIG. 4, virtual pen 51 has a pen height a, virtual pen 52 has a pen height b, virtual pen 53 has a pen height c and virtual pen 54 has a pen height d. The ink nozzles for virtual pens 51-54 are selected so that pen heights a-d are equal. The height of a given pen is proportional to the height of the pen swath printed by that pen on the print medium during printing.

Also shown in FIG. 4, virtual pen 52 is offset from virtual pen 51 by an offset distance x, virtual pen 53 is offset from virtual pen 52 by an offset distance y, and virtual pen 54 is offset from virtual pen 53 by an offset distance z. Typically, each pen is offset by an equivalent amount, that is, x=y=z. Such pens are referred to as ‘progressively offset’. As a result, the offset between any two pens is an integral multiple of the smallest offset distance between any two pens.

Where the pen is composed of a subset of nozzles from a larger number of ink nozzles, as shown in FIG. 4, the offset distance typically corresponds to one or more rows of nozzles. While any offset that results in staggering of the pens serves to reduce the visibility of banding errors, practically it has been found that an offset of 1-5 rows of nozzles between adjacent pens is sufficient to minimize obvious banding. Greater offset distances do not appreciably minimize banding further, and serve to functionally diminish the height of the resulting pens, and therefore the size of the swath that can be printed in a single pass of the pen carriage.

Although the pens of FIG. 4 are depicted as having a consistent pen height and consistent pen offset, virtual pens having any desired pen height or offset may be created by the selection of an appropriate subset of ink nozzles. In one embodiment of the invention, the pen height for a given pen may vary over the course of a particular print job. In particular the pen height may be varied at each pass of the print carriage, further reducing potential banding in the printer output.

In an alternative embodiment of the invention, rather than selecting a subset of nozzles in each pen of an existing pen arrangement, pens may be simply mounted such that each defines an array of ink nozzles that is physically offset relative to each other pen, as shown for pens 61-64 in pen arrangement 50 of FIG. 5. The pen offset and pen heights of the pen arrangement of FIG. 5 are otherwise equivalent to those depicted in FIG. 4, but pen arrangement 50 of FIG. 5 nominally includes no inactive ink nozzles.

Each pen of the pen arrangements depicted in FIGS. 2-5 incorporates two columns of ink nozzles, with the nozzles of one column staggered relative to the nozzles of the other column. While this configuration of ink nozzles is shown, a variety of other pen configurations exist, including single columns of ink nozzles, more or less nozzles per printhead, etc. etc. Any pen configuration that can be adapted to function as a staggered pen arrangement is a suitable pen configuration for the purposes of the invention.

In another physical configuration, the pen carriage incorporates two or more replaceable or disposable ink cartridges that incorporate individual pens. In this instance, the pen carriage of the invention may be modified so that each ink cartridge/pen may be staggered with respect to each other ink cartridge/pen, effectively resulting in staggering of the pens.

The creation of staggered pens by selection of subsets of ink nozzles in an existing pen configuration has the advantage of being readily applicable to printers already in use or presently commercially available, simply by providing a software upgrade to accomplish the ink nozzle selection and image data manipulation. A suitable software upgrade serves two functions: 1) the new software selectively disables the appropriate ink nozzles to create physically staggered virtual pens, as described above; and 2) the software manipulates any incoming electronic print job so as to feed appropriate print data to each pen for each pass of the pen carriage in order to print the desired image.

In a typical computer system, electronic documents or images are typically associated with an application program. The application is typically used to create or edit the document, or it is used for viewing or printing the document. When a document is selected to be printed, the corresponding application converts the document to a format that is specific for both the operating system used by the computer, and the printer driver that will send the document to the selected printer. One such format, used by the WINDOWS operating system (Microsoft Corporation) to represent graphical objects and transmit them to output devices, is the Graphical Device Interface format (or GDI).

The printer driver receives the document image data in the operating-system and printer-driver specific format, and converts it into an image in a printer-language format. Typically, the document image exists in a page description language, or PDL. Such formats include bit-mapped documents (or raster graphics), or object-based documents (or vector graphics). Selected page description languages include POSTSCRIPT (Adobe Systems Incorporated) and various versions of PCL (Printer Control Language, Hewlett-Packard Company).

The printer-language-formatted document image is then received by another program, typically resident in the printer, that converts it to a format suitable for sending to the print engine of the printer. As used herein, the “print engine” refers to the components of the printer that actually perform the printing, that is, that place the desired image onto the print medium. The print-ready format corresponds to the data stream that is interpreted by the print engine so that it may then produce the desired image on the print medium. The print-ready format is alternatively referred to as ‘printer-ready data’.

In the case of the instant invention, this print program must convert the electronic image received from the printer driver into pen data appropriate for the staggered pens of the invention. The pen data for a particular pen must be offset within the image from the pen data for each other pen in order for the correct pen swaths to be printed during each pass of the printer carriage, so that the resulting image corresponds to the electronic image received by the printer.

An example of selecting pen data within an electronic image is provided in FIG. 6, where the electronic image data 70 includes pen data start points 65, 66, 67, and 68, offset within the image by the pen data offsets x′, y′, and z′, respectively. The pen data offsets are proportional to the physical offset of each pen of the pen arrangement (x, y, and z in FIG. 4), and also correspond to the pen swath offsets in the resulting image. The pen data start points represent points within the image where pen data is fed to each pen in order for the desired image to be accurately reproduced by the print engine, and are a reflection of the offset exhibited by the physical pens themselves.

Considering only the pen data start points shown in FIG. 6, it would appear that an image resulting from such pen data would have an initial swath that is x high and that contains only ink from pen 51, a swath that is x+y high that contains only inks from pens 51 and 52, and so forth. In order to correct this artifact, a first pass is performed by the printer that prints a swath that is x+y+z in height, and that contains the appropriate partial swaths of ink from pens 52, 53, and 54. The second or subsequent pass can then begin with the top of pen 51 aligned with the top of the printed image. Similarly, a ‘partial’ swath is required at the bottom of the printed image, in order to insure a complete image is printed containing ink from each pen. In this way a complete image can be printed with the appropriate amount of ink applied from each pen in every portion of the image.

The print program of the invention may be resident and executed in a processor located in the printer of the invention, or may be resident and executed in a computer in communication with the printer of the invention. The print program is preferably executed by a processor located in the printer itself. The print program is optionally made available on a computer-readable storage medium so that a previously purchased inkjet printer can be upgraded and used as an inkjet printer of the invention. The print program accomplishes this upgrade via the selection of subsets of nozzles to yield staggered virtual pens, and the appropriate shifting of pen data during processing of image data, as described above. The print program may be printer specific, or it may be appropriate for installation in a variety of printers.

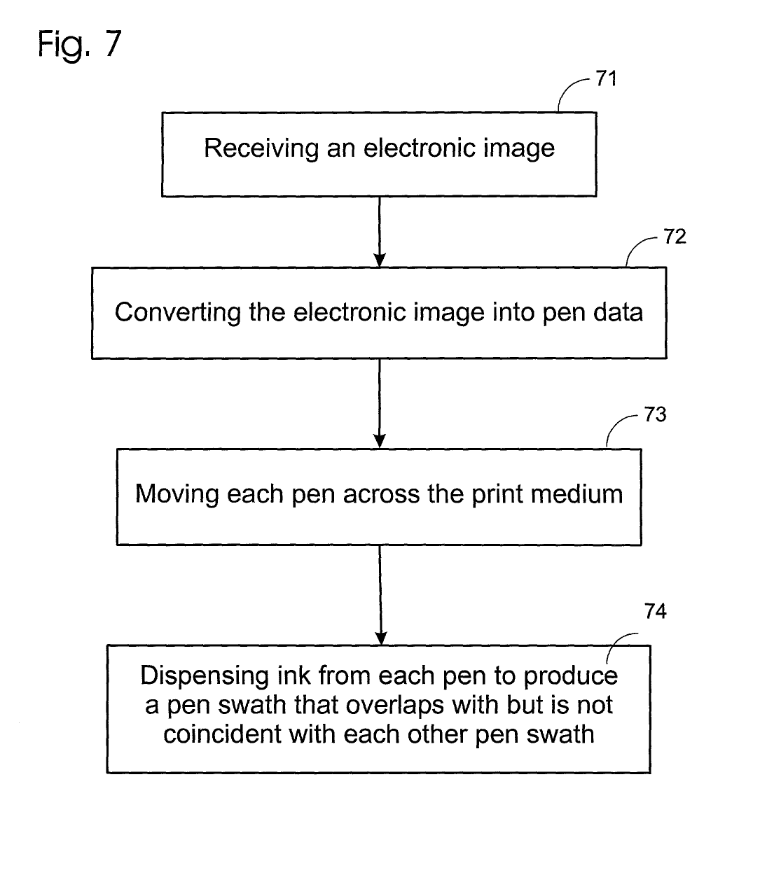

A method of printing that utilizes the print program of the invention is depicted in the flow diagram of FIG. 7. The print program first receives an electronic image, typically as a print job sent to the printer of the invention, as shown in block 71. The print program then converts the electronic image into pen data, including the appropriate shifting of pen data to accommodate the amount of pen offset in the printer of the invention, as shown in block 72. Each pen is then moved across the print medium, as shown in block 73, and ink is dispensed from each pen to produce the desired image in pen swaths that overlap, but are not coincident with, each other pen swath, as shown in block 74.

Although the present invention has been shown and described with reference to the foregoing operational principles and preferred embodiments, it will be apparent to those skilled in the art that various changes in form and detail may be made without departing from the spirit and scope of the invention. For example, the print medium used in the printer of the invention may be paper, coated or treated paper, transparency sheets, or any other appropriate print medium. The print medium may be advanced in the printer by a platen, by pinch rollers, or any other suitable advance mechanism. The printer of the invention may incorporate any suitable mechanism for dispensing ink. Any type of ink may be utilized in the printer of the invention. The present invention is intended to embrace all such alternatives, modifications and variances which fall within the scope of the appended claims.

I claim:

1. A method of reducing output banding in an inkjet printer having at least two pens, each pen configured to selectively dispense ink onto a print medium, the method comprising the steps of:
moving the pens across the print medium;
dispensing ink from each pen to produce a swath on the print medium corresponding to each pen, where the relative position of each pen is such that the swath produced by each pen overlaps with, but is not coincident with, the swath produced by any other pen.

2. The method of claim 1, where each swath is substantially the same height.

3. The method of claim 1, where each pen comprises a plurality of ink nozzles.

4. The method of claim 3, where the ink nozzles of each pen are a subset of a larger number of ink nozzles, and where the subset corresponding to each pen is offset with respect to the subset corresponding to each other pen.

5. The method of claim 1, where the inkjet printer includes at least four pens.

6. The method of claim 5, where the four pens dispense cyan, magenta, yellow, and black inks.

7. The method of claim 1, where the swath printed by a first pen corresponds to image data sent to that pen, where the image data is offset within the image relative to the image data sent to each other pen by the relative amount that each other pen is offset from the first pen.

8. An inkjet printer, comprising:
a first pen, configured to selectively dispense a first ink onto a print medium in a first swath; and
a second pen, configured to selectively dispense a second ink onto the print medium in a second swath;
where the position of the second pen is offset relative to the position of the first pen, so that the second swath overlaps with, but is distinct from, the first swath.

9. The inkjet printer of claim 8, further comprising a third pen, configured to selectively dispense a third ink onto a print medium in a third swath; and
a fourth pen, configured to selectively dispense a fourth ink onto the print medium in a fourth swath;
where the positions of the third and fourth pens are offset relative to the positions of each other pen, so that each of the first, second, third, and fourth swaths overlaps with, but is distinct from, each of the other swaths.

10. The inkjet printer of claim 9, where the first, second, third, and fourth pens are progressively offset.

11. The inkjet printer of claim 9, where the first, second, third, and fourth pens dispense cyan, magenta, yellow, and black inks, respectively.

12. The inkjet printer of claim 8, where each pen includes a plurality of ink nozzles.

13. The inkjet printer of claim 8, where the ink nozzles of each pen are a subset of a larger number of ink nozzles, and where the subset corresponding to each pen is offset with respect to the subset corresponding to each other pen.

14. The inkjet printer of claim 13, where each pen is offset by an integral number of nozzles from each other pen.

15. A computer-readable storage medium having computer-readable program code embodied in the medium, the computer-readable program code configured so that when executed in conjunction with an inkjet printer having a plurality of pens, the program is capable of performing the steps of:
receiving an electronic image;
converting the electronic image into pen data;
moving each pen across a print medium; and
dispensing ink from each pen to produce a swath on the print medium corresponding to the pen data for that pen, so that the pen swath for each pen is offset relative to the pen swath for every other pen, and each pen swath overlaps with, but is distinct from, each other pen swath.

16. The computer-readable storage medium of claim 15, where the pen data for each pen is offset within the electronic image from the pen data for each other pen by an amount proportional to the relative offset of their respective pen swaths on the print medium.

17. A printer system, comprising:
at least two pens; and
a processor configured to perform the following steps:
convert an electronic document into pen data;
move each pen across a print medium; and
dispense ink from each pen to produce a swath on the print medium corresponding to the pen data for that pen, where the pen swath for each pen is offset relative to the pen swath for every other pen, so that each pen swath overlaps with, but is not coincident with, each other pen swath, and where the pen data is offset within the electronic document relative to the pen data for each other pen by an amount proportional to the relative offset of their respective pen swaths on the print medium.

18. The printer system of claim 17, where each pen includes a subset of a plurality of ink nozzles, and where the relative offset of each pen swath corresponds to the relative offset of each subset of nozzles.

19. The printer system of claim 18, where the offset between any two subsets of nozzles is an integral multiple of the smallest offset between two subsets of nozzles.

20. The printer system of claim 19, where the smallest offset between two subsets of nozzles is 1-5 nozzles.

21. The printer system of claim 20, where the printer has at least four pens that dispense cyan, magenta, yellow, and black inks, respectively.
